(19) United States
(12) Patent Application Publication
(10) Pub. No.: US 2007/0036047 A1
(43) Pub. Date: Feb. 15, 2007

(54) Dual-deck optical disc system and copy method thereof

(75) Inventor: Dong Ik Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/499,714

(22) Filed: Aug. 7, 2006

(30) Foreign Application Priority Data
Aug. 10, 2005 (KR) 2005-73471

(51) Int. Cl. G11B 20/10

(52) U.S. Cl. 369/47.12

(57) ABSTRACT

A dual-deck optical disc system, including a first deck into which a recordable optical disc is inserted, a second deck into which an original optical disc is inserted, and a controller. The controller checks whether contents to be copied from the original optical disc of the second deck are able to be copied without predetermined errors to the recordable optical disc of the first deck upon an input of a copy command. The controller also displays an error based on a negative result of the checking.

### CROSS-REFERENCE TO RELATED APPLICATIONS

This application claims the benefit of Korean Application No. 2005-73471, filed Aug. 10, 2005 in the Korean Intellectual Property Office, the disclosure of which is incorporated herein by reference.

### BACKGROUND OF THE INVENTION

1. Field of the Invention

An aspect of the present invention relates to a dual-deck optical disc system, and, more particularly, to a dual-deck optical disc system including two decks and a method of performing copy operations using the two decks.

2. Description of the Related Art

Generally, a conventional optical disc system with a single deck copies contents stored on an original optical disc to a recordable optical disc. This is accomplished by, first, inserting the original optical disc in the single deck, reading data stored in the original optical disc, and then storing the data in a Hard Disk Drive (HDD). Then the original optical disc is removed from the single deck and the recordable optical disc is inserted in the deck. The data stored in the HDD is then transferred to the recordable optical disc to for storage therein.

The conventional single deck optical disc system, which is operated as described above, is disadvantageous in that, since the operation of reading data from the original optical disc and the operation of storing that data in the recordable optical disc are performed individually and separately, the operation of copying data from the original optical disc to the recordable optical disc requires a relatively long operational time.

On the other hand, a conventional optical disc system with dual decks performs a copy operation differently. First, an original optical disc is inserted into one deck of the conventional optical disc system and a recordable optical disc is inserted into another deck of the conventional optical disc system. Data stored in the original optical disc is then transferred to the recordable optical disc where the data is written to and stored in the recordable optical disc.

The conventional dual-deck optical system reduces the required copy time compared with the conventional single deck optical disc since the dual-deck optical disc system is able to perform a reproducing operation for one deck and a recording operation for another deck simultaneously.

The conventional dual-deck optical system may be used with various types of optical discs, such as Digital Versatile Discs—Read Only Memory (DVD-ROMs), Digital Versatile Discs—Recordable (DVD-Rs), Digital Versatile Discs—ReWritable (DVD-RWs), Digital Versatile Discs—Random Access Memory (DVD-RAMs), etc. These optical discs have various formats, such as a V-mode, and VR-mode. When a format of an original optical disc is not identical to that of a recordable optical disc, in many cases a copy operation cannot be performed therebetween. In other cases, the copy operation may be attempted, but the result of the copy operation may likely include errors. Therefore, format structures between the original optical disc and the recordable optical disc must be previously identified such that users can properly use them. However, identifying such formats of the optical discs may be difficult for some users. Also, although the users may try to identify the formats of the optical discs, the optical discs must be identified one by one.

Also, the conventional optical disc system has other disadvantages in that, when data is previously recorded in the recordable optical disc, a copy operation is performed with consideration given to the remaining recordable capacity on the recordable disc. Thus, users must identify the remaining recordable capacity before beginning the copy operation.

Therefore, it is required that contents in the original optical disc be simply copied to a recordable optical disc. It is further required that the contents, which are to be recorded in the recordable optical disc, be viewable and able to be listened to while the contents in the optical disc are copied to the recordable optical disc.

### SUMMARY OF THE INVENTION

Several aspects and example embodiments of the invention provide a dual-deck optical disc system with dual decks, and a method of easily and conveniently performing copy operations for optical discs mounted in the dual decks according to demands of users, even where the user has not identified particular information relating to the optical discs.

In accordance with an embodiment of the present invention, a dual-deck optical disc system is provided, including a first deck into which a recordable optical disc is inserted, a second deck into which an original optical disc is inserted, and a controller. The controller checks whether contents to be copied from the original optical disc of the second deck are able to be copied without predetermined errors to the recordable optical disc of the first deck upon an input of a copy command. The controller also displays an error based on a negative result of the checking.

According to an aspect of the invention, the dual deck optical disc system further includes a reproducing signal processor to read the contents in the original optical disc; and a recording/reproducing signal processor to store the contents in the recordable optical disc.

According to an aspect of the invention, the controller obtains state information of the original optical disc and the recordable optical disc and determines whether an error exists based on the obtained information. The controller displays an error when the format of the recordable optical disc is not identical to that of the original optical disc and/or the controller displays an error when the recordable optical disc has insufficient capacity.

In accordance with another embodiment of the present invention, there is provided a method of copying data for use with an optical disc system with dual decks, comprising inputting a copy command to initiate a copying of contents stored in an original optical disc to a recordable optical disc where the recordable optical disc is inserted in a first deck and the original optical disc is inserted in a second deck of the optical disc system, checking whether all or part of the contents in the original optical disc are able to be copied to the recordable optical disc without predetermined errors, and displaying an error corresponding to an indication that the copying cannot be performed based on the result of the checking.

According to an aspect of the present invention, such a method further includes the checking whether the format of the recordable optical disc is identical to that of the original optical disc, and displaying an error if the format of the recordable optical disc is not identical to that of the original optical disc.

According to an aspect of the present invention, such a method further includes checking whether the capacity of the recordable optical disc is sufficient to contain the contents of the original optical disc to be copied, and displaying an error if the capacity of the recordable optical disc is insufficient.

According to an aspect of the present invention, such a method further includes displaying a deletion message indicating that data previously recorded in the recordable optical disc has been deleted, when the copy operation cannot be normally performed on the basis of the check result.

According to an aspect of the present invention, such a method further includes: designating a title of corresponding contents of the contents in the original optical disc; encoding/decoding for the designated title based on image quality which is previously set for the designated title; and storing the encoding/decoding result in the recordable optical disc.

According to an aspect of the present invention, such a method further includes simultaneously performing a copy operation where the contents in the original optical disc are copied to the recordable optical disc and a reproducing operation whereby the copied contents are reproduced.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is illustrates a schematic block diagram of a dual-deck optical system according to an embodiment of the present invention; and

FIG. 2 illustrates a flow chart for describing a copy method of the dual-deck optical disc system according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

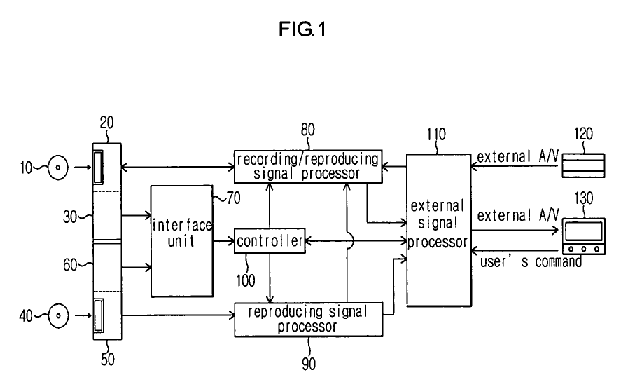

FIG. 1 is illustrates a schematic block diagram of a dual-deck optical system according to an embodiment of the present invention. As shown in FIG. 1 the dual-deck optical system includes a first deck 20 to record data onto and reproduce data from an optical disc 10, and a second deck 50 to reproduce data from an optical disc 40. The dual-deck optical system may operate compatibly with a DVD-ROM, a DVD-R, a DVD-RW, a DVD-RAM, etc., each of which may have different formats, e.g., a V-mode, and a VR-mode.

Each of the first and second decks 20 and 50 includes an optical pick-up and an optical pick-up driver, to emit a laser beam toward the optical discs 10 and 40 that records and/or reproduces data to and/or from the optical discs 10 and 40. Each of the first and second decks 20 and 50 further includes first and second key input units 30 and 60 to input commands of a user that are related to processing operations of the optical discs 10 and 40. Here, the first and second key input units 30 and 60 may be integrated to form a single key input unit.

The commands of the user, which are inputted through the first and second key input units 30 and 60, are provided to a controller 100, via an interface unit 70. The controller 100 controls all of the operations of the elements in response to the commands of the user.

A recording/reproducing signal processor 80 encodes data that is read from the optical disc 10 of the first deck 20 so as to render the data to be able to be transferred to an external signal processor 110. The external signal processor 110 then processes the received data so as to generate corresponding image and audio data, which is then transmitted to an external device (i.e., a TV 130). The external signal processor 110 also processes external video and audio signals (external A/V signals), which are inputted from a tuner 120, and then transmits the external A/V signals to the recording/reproducing signal processor 80. The recording/reproducing signal processor 80 decodes the external A/V signals so as to be able to record the A/V signals in the optical disc 10 of the first deck 20. On the other hand, the external processor 110 inputs the external A/V signals from the tuner 120 to process them to output corresponding image and audio data. Afterwards, the processed result is transmitted to an external device such as a TV 130.

A reproducing signal processor 90 encodes data that is read from the optical disc 40 of the second deck 50. The reproducing signal processor 90 also transmits the encoded data to the TV 130 through the external signal processor 110 in a process of performing a reproducing operation. In addition, the reproducing signal processor 90 transmits the data from the optical disc 40 to the recording/reproducing signal processor 80 in a process of performing a recording operation.

When the commands of the user provided from the TV 130, such as a guide message displayed on a TV screen, are selected by an input key of the TV or a remote controller, the input commands are provided to the controller 100 through the external signal processor 110. Therefore, the controller 100 is able to control substantially all operations of elements involved in the operation of the dual-deck optical disc system based on the commands of the user.

The following is a detailed description of a method in which all or a part of the contents in an original optical disc are copied to a recordable optical disc.

First, the recordable optical disc 10 is inserted in the first deck 20 and the original optical disc is inserted in the second deck 50. Afterwards, the user inputs a copy command in the dual-deck optical disc system. Here, the copy command is classified into a direct copy key or a title list key. The direct copy key copies all of the contents of the original optical disc 40 to the recordable optical disc 10. The title list copy key sets a ‘copy mode’ in which titles relating to only certain contents of the original optical disc 40 are selectively copied to the recordable optical disc. That is, the title list copy mode selectively copies only desired titles and the direct copy mode copies the whole contents of the original optical disc 40. In accordance with an embodiment of the invention, the command of the title list copy key is substantially identical to the copy command corresponding to the direct copy key.

The direct copy key is installed in each of the first and second key input units 30 and 60 such that users are able to use the direct copy key relatively easily. The title list key is a command of the user that is inputted by the remote controller, etc. through the TV screen. Namely, the command of the user corresponding to the title list key is inputted to the controller 100, based on a message format, through the external signal processor 110.

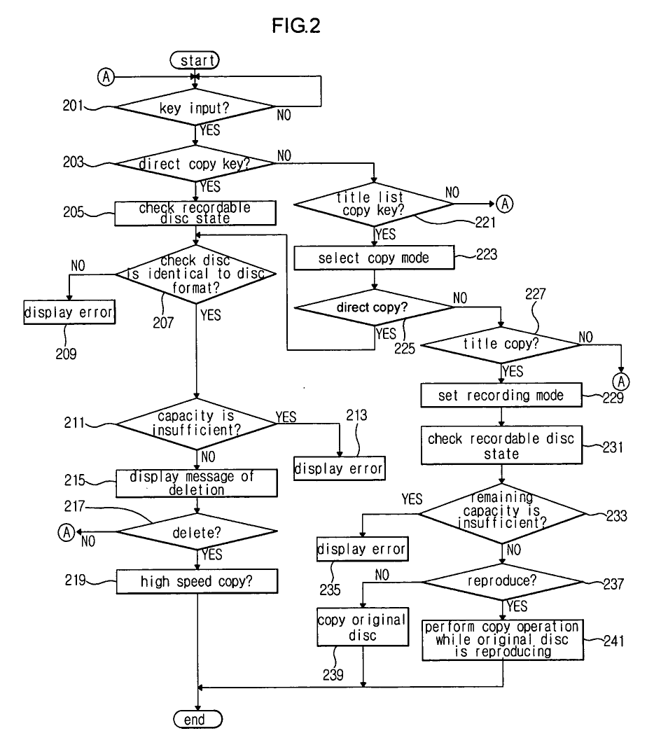

The dual-deck optical disc system performs a preparation procedure before the contents of the original optical disc 40 are copied to the recordable optical disc 10 in response to the input of the copy command. The preparation procedure includes a process of obtaining information related to the optical discs 10 and 40 which are inserted to the first and second decks 20 and 50, respectively. The controller 100 checks whether there are error conditions such that copy operations cannot be performed, based on the obtained information, and then displays errors that correspond to the result of the checking. The displaying of the errors allows for an identification of the causes of the errors. With the errors being identified, users may take necessary actions to correct the errors such that copy operations may be operated normally. Here, the error conditions in which copy operations cannot be performed include, but are not limited to, a case where the format of the original optical disc is not identical to that of the recordable optical disc, and a case where the remaining recordable capacity of the recordable optical disc is not sufficient. Such cases will be described in detail below with reference to FIG. 2, which is a diagram of a method of copying data from an optical disc that is inserted into one deck of a dual-deck optical disc system to another optical disc that is inserted into the other deck of the dual deck optical disc system according to embodiments of the present invention.

First, the recordable optical disc 10 is inserted into the first deck 20 of the dual-deck optical disc system and the original optical disc 40 the dual-deck optical disc system is inserted into the second deck 50 of the dual-deck optical system. Here, basic information related to the optical discs 10 and 40 is obtained by the controller 100, as shown in FIG. 1.

The controller 100 determines whether a key input corresponding to the copy command is operated in operation 201. When the copy command is found to have been inputted based on the determination result, the controller determines whether the copy command corresponds to a direct copy key in operation 203. When the direct copy key is found to have been operated based on the determination result, a state of the recordable optical disc 10 is checked in operation 205. Then, whether the format of the original optical disc 40 is identical to that of the recordable optical disc 10 is determined in operation 207. When the determination of operation 207 is found to be negative, an error is displayed such that the user of the dual-deck optical disc system is able to identify the error in operation 209. Here, the error is displayed on the TV 130 through the external signal processor 110 or on a liquid crystal display (LCD) (not shown). When the LCD is adopted for use with the system, according to embodiments of the invention, either one LCD is used, or first and second LCDs are installed at each of the first and second decks 20 and 50, respectively. Of course, it is understood that there are other LCD structures and arrangements available for use with the present invention.

On the other hand, when the determination of operation 207 is found to be positive, another determination that relates to whether the capacity of the recordable optical disc 10 is insufficient is performed, in operation 211, the determination being based on the capacity of the original optical disc 40. When the determination of operation 211 is found to be positive, an error is displayed to notify the user of the system in operation 213.

When the determination of operation 211 is found to be negative, a message indicating that data of the recordable optical disc will be deleted according to an input of the user is displayed to the user of the system in operation 215. Then, a determination is performed, in operation 217 to determine whether a deletion command is inputted. When the deletion command is found to not have been inputted, the procedure returns to operation 201.

On the other hand, when the deletion command is found to have been inputted, the controller controls the reproducing signal processor 90 to transmit the data read from the original optical disc 40 to the recording/reproducing signal processor 80. At the same time, the controller controls the recording/reproducing signal processor 80 to perform a series of high speed copyings in which transmitted data is stored in the recordable optical disc 10. Here, the reproducing signal processor 90 only reads the data without an encoding operation, and the recording/reproducing signal processor 80 stores the read data, in the recordable optical disc without a decoding operation, in operation 219.

When the determination of operation 203 is found to be negative, or when the copy command does not correspond to the direct copy key, a determination is performed to determine whether the copy command corresponds to a title list copy key, in operation 221. When the determination of operation 221 is found to be positive, the controller 100 allows the users to select a copy mode. A determination is then performed to determine whether the selected copy mode is a direct disc copy mode, in operation 225. When the determination of operation 225 is found to be positive, the procedure proceeds to operation 207. On the other hand, when the determination of operation 225 is found to be negative, a determination is performed to determine whether the selected copy mode is a title copy mode in operation 227.

When the determination of operation 227 is found to be positive, the controller allows the users to set a recording mode. Here, the recording mode is set such that titles to be copied are designated in the contents of the original optical disc, image quality relating to the designated titles is set in the recordable optical disc regardless of the quality of contents in the original optical disc, and a condition is set as to whether a reproducing operation is performed when the designated titles are copied in operation 229.

When the recording mode setting is completed, a state of the recordable optical disc 10 is checked in operation 231. A determination is then performed to determine whether the remaining recordable capacity of the recordable optical disc 10 is insufficient based on the capacity required for the titles to be copied in operation 233. When the determination of operation 233 is found to be positive, or when the remaining recordable capacity of the recordable optical disc 10 is found to be insufficient, an error is displayed in operation 235. On the other hand, when the determination of operation 233 is found to be negative, a determination is performed to determine whether the system is set to reproduce the titles to be copied in operation 237. When the system is not set to reproduce the titles, data relating to the titles to be copied from the original optical disc 40 is encoded based on a level of an image quality, which is set in the reproducing signal processor 90 and which is then transmitted to the recording/reproducing signal processor 80. The recording/reproducing signal processor 80 decodes the data of the titles to be copied and then stores the data in the recordable optical disc 10. Here, the TV 130 displays only a basic guide image but does not reproduce contents corresponding to the titles in operation 239.

On the other hand, when the system is set to reproduce the titles in operation 237, the data of titles to be copied from the original optical disc 40 is encoded based on a level of an image quality of the reproducing signal processor 90 and is then transmitted to the recording/reproducing signal processor 80 and to the TV 130 through the external signal processor 110, simultaneously. The recording/reproducing signal processor 80 decodes the data of titles to be copied, to store the data in the recordable optical disc 10, and simultaneously, reproduces the contents corresponding to the titles on the TV 130, such that users are able to watch and listen to the contents, in operation 241.

As is describe above, according to aspects of the present invention, the present invention checks whether contents of the original optical disc are copied to the recordable optical disc, and displays an error when a copy operation cannot be performed normally such that user can take necessary corrective actions. Also, the present invention performs a copy operation based on various methods according to requests of the user. In addition, the present invention does not request that user identify particular information for the recordable optical discs. Furthermore, the present invention simultaneously performs a copy operation for contents in the original optical disc and a reproducing operation for the copied contents, such that user are able to watch and listen to the contents.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A dual-deck optical disc system, comprising:
a first deck into which a recordable optical disc is inserted;
a second deck into which an original optical disc is inserted; and
a controller to check whether contents to be copied from the original optical disc inserted in the second deck are able to be copied without predetermined errors to the recordable optical disc inserted in the first deck upon an input of a copy command, and to display an error based on a negative result of the checking.

2. The system according to claim 1, further comprising:
a reproducing signal processor to read the contents in the original optical disc inserted in the second deck; and
a recording/reproducing signal processor to store the contents in the recordable optical disc inserted in the first deck.

3. The system according to claim 1, wherein the controller obtains state information of the original optical disc and the recordable optical disc and determines whether an error exists based on the obtained information.

4. The system according to claim 3, wherein the controller displays an error when the format of the recordable optical disc is not identical to that of the original optical disc.

5. The system according to claim 3, wherein the controller displays an error when the recordable optical disc has insufficient capacity to store the contents to be copied.

6. A method of copying data for use with an optical disc system with dual decks, comprising:
inputting a copy command to initiate a copying of contents stored in an original optical disc to a recordable optical disc where the recordable optical disc is inserted in a first deck and the original optical disc is inserted in a second deck of the optical disc system;
checking whether all or part of the contents in the original optical disc are able to be copied to the recordable optical disc without predetermined errors; and
displaying an error indicating that the copying cannot be performed based on the result of the checking.

7. The method according to claim 6, further comprising:
checking whether the format of the recordable optical disc is identical to that of the original optical disc; and
displaying an error if the format of the recordable optical disc is not identical to that of the original optical disc.

8. The method according to claim 6, further comprising:
checking whether a capacity of the recordable optical disc is sufficient to contain the contents of the original optical disc be copied; and
displaying an error if the capacity of the recordable optical disc is found to be insufficient to store the contents to be copied.

9. The method according to claim 6, further comprising displaying a deletion message indicating that data previously recorded in the recordable optical disc has been deleted when the copy operation is not performed based on the result of the checking.

10. The method according to claim 6, further comprising:
designating a title of corresponding contents of the contents to be copied from the original optical disc;
encoding/decoding for the designated title based on image quality which is previously set for the designated title; and
storing a result of the encoding/decoding in the recordable optical disc.

11. The method according to claim 6, further comprising simultaneously performing a copy operation where the contents in the original optical disc are copied to the recordable optical disc and a reproducing operation whereby the copied contents are reproduced.

12. A system, in which first and second discs are loaded onto first and second decks, and in which contents of one of the discs are to be copied to the other disc, the system comprising a controller to check whether the first and second discs have identical formats and, if the first and second discs have identical formats, to check whether the other disc has sufficient capacity to store the contents to be copied.

13. The system according to claim 12, further comprising:
a reproducing signal processor to read the contents to be copied; and
a recording/reproducing signal processor to store the contents in the other disc.

14. The system according to claim 12, wherein the controller obtains state information relating to the first and second discs and checks the formats of the discs and the capacity of the other disc based on the obtained state information.

15. The system according to claim 14, wherein the controller displays an error when the formats of the discs are not identical.

16. The system according to claim 14, wherein the controller displays an error when the other discs is found to have insufficient capacity to store the contents to be copied.

17. A dual-deck optical disc system, comprising:
a first deck on which a recordable optical disc is placed;
a second deck on which an original optical disc is placed, the original optical disc including contents to be copied to the recordable optical disc; and
a controller to copy the contents from the original optical disc to the recordable optical disc unless, upon an input of a command to initiate the copying of the contents, the discs are found to have different formats, or, if the formats are the same, the recordable optical disc is found to not have sufficient capacity to store the contents.

18. The method according to claim 17, wherein the controller does not proceed with the copying and displays that an error has occurred if the formats of the discs are found to be different or is the recordable disc is found to not have the sufficient capacity, the display indicating a nature of the error.

19. A method of operating a dual deck optical system that receives a command to copy data from an original optical disc to a recordable optical disc, the method comprising:
determining whether the original optical disc and the recordable optical disc have the same formats;
if the formats are found to be same, determining whether the recordable optical disc includes sufficient capacity to store the data to be copied; and
if the recordable optical disc is found to include the sufficient capacity, copying the data from the original optical disc to the recordable optical disc.

20. The method according to claim 19, further comprising not proceeding with the copying and displaying that the copying cannot be performed, if either the formats are found to be different or the recordable optical disc is found lacking the sufficient capacity, the displaying indicating a reason why the copying cannot be performed.

21. The method according to claim 19, further comprising:
deleting data that has been recorded on the optical disc in accordance with the copying if either the formats are found to be different or the recordable optical disc is found lacking the sufficient capacity; and
indicating that the data has been deleted.

22. The method according to claim 19, further comprising:
designating a title of contents to be copied from the original optical disc;
encoding/decoding the contents for the designated title based on image quality which is previously set for the designated title; and
storing a result of the encoding/decoding on the recordable optical disc.

23. The method according to claim 19, further comprising simultaneously performing the copying and a reproducing operation.
